(19) United States
(12) Patent Application Publication
(10) Pub. No.: US 2025/0307172 A1
(43) Pub. Date: Oct. 2, 2025

(54) METHOD FOR BYPASSING SUBSEQUENT LOOKUPS IN PACKET PROCESSING PIPELINES

(71) Applicant: XILINX, INC., San Jose, CA (US)

(72) Inventors: Thomas CALVERT, Cambridge (GB); Matthew SLATTERY, Cambridge (GB)

(21) Appl. No.: 18/619,095

(22) Filed: Mar. 27, 2024

(51) Int. Cl. G06F 12/1009

(52) U.S. Cl. CPC G06F 12/1009

(57) ABSTRACT

Systems and methods for bypassing subsequent lookups in packet processing pipelines in which multiple circuit blocks includes pre-processing circuitry that determine keys based on parsed contents of packets, and that retrieve responses from respective look-up tables (LUTs) based on the keys. The LUT of a first one of the blocks may be programmed with keys and/or responses for other ones of the circuit blocks, and the first circuit block may provide the keys and/or responses in metadata of the packets. Alternatively, or additionally, the first circuit block may provide parsed contents of the packets in the metadata of the respective packets. The other circuit blocks may selectively bypass the respective pre-processing circuitry based on the metadata.

### TECHNICAL FIELD

Examples of the present disclosure generally relate to methods for bypassing subsequent lookups in packet processing pipelines.

### BACKGROUND

A packet processing platform may include multiple processing blocks (e.g., arranged in a pipeline fashion). In order to reduce development time and/or costs, some of the processing blocks may be reused/copied from prior versions of the platform and/or from other platforms. As a result, some of the processing blocks may perform redundant processes, which add unnecessary latency and/or power consumption. As an example, packet processing involves table lookups based on packet fields and multiple processing blocks of a packet processing pipeline may perform table lookups for the same packet. Latency and/or power consumption due to a single redundant table lookup may be relatively small (e.g., on the order of nanoseconds). In a packet processing pipeline, however, the numbers of redundant lookups may be astronomical, and the associated latencies and/or power consumption may be substantial. Re-designing the processing blocks may be impractical and/or prohibitively expensive.

### SUMMARY

Techniques for bypassing subsequent lookups in packet processing pipelines are described. One example is an integrated circuit (IC) system that includes a circuit block having packet pre-processing circuitry that pre-processes a packet, where the pre-processing includes retrieving a response from a look-up table (LUT) based on a key. The IC system further includes packet processing circuitry that processes the packet based on the response, and bypass circuitry that selectively bypasses at least a portion of the pre-processing circuitry based on metadata of the packet.

Another example is an IC device that includes a circuit block having packet pre-processing circuitry that pre-processes a packet, where the pre-processing includes retrieving a response from a LUT based on a key, and packet processing circuitry that processes the packet based on the first response, where the circuit block selectively bypasses at least a portion of the pre-processing circuitry based on metadata of the packet.

Another example is a system that includes a packet processing pipeline that processes a stream of packets. The packet processing pipeline includes a first circuit block having packet pre-processing circuitry that pre-processes a packet, where the pre-processing includes determining a key based on parsed contents of the packet, and retrieving a response from a LUT based on the key, the response includes pre-processing data for other circuit blocks of the packet processing pipeline, the pre-processing data includes one or more of keys and responses for other circuit blocks, and the first circuit block provides the pre-processing data in metadata of the packet.

### BRIEF DESCRIPTION OF DRAWINGS

So that the manner in which the above recited features can be understood in detail, a more particular description, briefly summarized above, may be had by reference to example implementations, some of which are illustrated in the appended drawings. It is to be noted, however, that the appended drawings illustrate only typical example implementations and are therefore not to be considered limiting of its scope.

FIG. 1 is a block diagram of an integrated circuit (IC) system, according to an embodiment.

FIG. 2 is another block diagram of the IC system, according to an embodiment.

FIG. 3 is a block diagram of the IC system in which a first circuit block operates in a legacy or non-bypass mode, according to an embodiment.

FIG. 4 is a block diagram of the IC system in which the first circuit block operates in a parser bypass mode, according to an embodiment.

FIG. 5 is a block diagram of the IC system in which the first circuit block operates in a look-up bypass mode, according to an embodiment.

FIG. 6 is a block diagram of IC system in which the first circuit block operates in a key determination bypass mode, according to an embodiment.

FIG. 7 is a block diagram of the IC system in which the first circuit block operates in a multi-circuit bypass mode, according to an embodiment.

FIG. 8 is a block diagram of the IC system in which a second circuit block provides keys, responses, and/or parsed contents of a stream of packet to multiple circuit blocks that are arranged in a parallel fashion, according to an embodiment.

FIG. 9 is a block diagram of the IC system in which the second circuit block provides keys, responses, and/or parsed contents of a stream of packets to multiple circuit blocks that are arranged in a serial fashion, according to an embodiment.

FIG. 10 illustrates a method of bypassing subsequent lookups in a packet processing pipeline, according to an embodiment.

FIG. 11 is a block diagram of a distributed services platform, according to an embodiment.

To facilitate understanding, identical reference numerals have been used, where possible, to designate identical elements that are common to the figures. It is contemplated that elements of one example may be beneficially incorporated in other examples.

### DETAILED DESCRIPTION

Various features are described hereinafter with reference to the figures. It should be noted that the figures may or may not be drawn to scale and that the elements of similar structures or functions are represented by like reference numerals throughout the figures. It should be noted that the figures are only intended to facilitate the description of the features. They are not intended as an exhaustive description of the features or as a limitation on the scope of the claims. In addition, an illustrated example need not have all the aspects or advantages shown. An aspect or an advantage described in conjunction with a particular example is not necessarily limited to that example and can be practiced in any other examples even if not so illustrated, or if not so explicitly described.

Embodiments herein describe methods for bypassing subsequent lookups in packet processing pipelines.

The terms “intellectual property reuse” and “IP reuse” refer to a circuit design practice in which circuit blocks of one or more prior circuit designs are used in a subsequent circuit design. IP reuse may reduce development time and costs, but may result in circuit blocks that perform the same function. As an example, a packet processing pipeline may include a collection of circuit blocks that perform respective processes on a stream of packets (e.g., checksums, encryptions, and/or other processes). The processing blocks may include pre-processing circuits that parse contents of the packets, determine keys based on the parsed contents, and retrieve responses (i.e., pre-programmed data) from look-up tables LUT(s) based on the keys. Such redundant circuit/processes may increase latency, area requirements, and/or power consumption.

Methods for bypassing subsequent lookups in packet processing pipelines include methods for allowing a first circuit block to provide pre-processing data (e.g., parsed packet contents, LUT keys, and/or LUT responses) to other circuit blocks, and methods for allowing the other circuit blocks to bypass respective pre-processing circuitry, or portions thereof. The LUT of the first circuit block may be programmed with keys and/or responses for the other circuit blocks, and the first circuit block may provide the keys and/or responses in metadata of the packets. Alternatively, or additionally, the first circuit block may provide parsed contents of the packets in the metadata of the respective packets. The other circuit blocks may selectively bypass the respective pre-processing circuitry based on the metadata.

Methods disclosed herein may be useful to increase packet rates (i.e., a rate at which a circuit block processes packets), which may increase a throughput rate of a packet processing pipeline (i.e., reduce latency). In an example, methods disclosed herein may be useful to reduce latency by, for example and without limitation, tens of nanoseconds for each packet processed by each of the other circuit blocks, which may represent considerable savings over time.

Methods disclosed herein may be useful to reduce redundant processes of a packet processing pipeline.

Methods disclosed herein may be useful to reduce power consumption.

Methods disclosed herein may be useful in one or more of a variety of packet processing applications such as, without limitation, network interface controllers (NICs), packet switches, and/or other appliances.

Methods disclosed herein may be useful in hardware-based pipelines and/or software-based pipelines.

Methods disclosed herein may be useful in non-packet based systems that perform redundant look-ups.

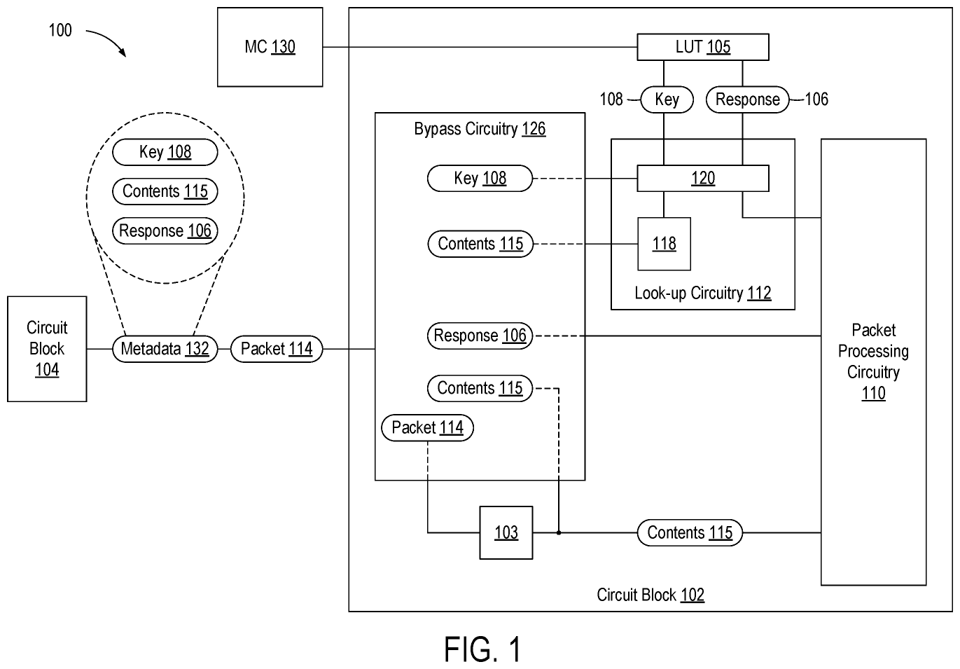

FIG. 1 is a block diagram of an integrated circuit (IC) system 100, according to an embodiment. IC system 100 may represent a single IC device, such as a single IC die, multiple IC dies (e.g., in a stacked or planar configuration), a system-on-chip (SoC), or multiple IC devices, such as multiple interconnected IC dies and/or multiple interconnected circuit cards.

IC system 100 may represent a packet processing pipeline, or a portion thereof. As an example, and without limitation, IC system 100 may represent a hardware-based network processing device, such as a network interface controller (NIC), a network switch, and/or other device. As another example, IC system 100 may represent a software-based packet processing pipeline (i.e., a processor and memory configured with instructions/code). Features disclosed here with respect to IC system 100 may also be useful in non-packet processing applications that perform redundant memory look-ups.

In the example of FIG. 1, IC system 100 includes circuit blocks 102 and 104. Circuit block 102 includes a look-up table (LUT) 105. LUT 105 may include keys and associated responses (i.e., data), and may output a response 106 to a key 108. Circuit block 102 further includes parser circuitry 103 that parses contents 115 of packet 114.

Circuit block 102 further includes look-up circuitry 112 that includes key determination circuitry 118 and interface circuitry 120. Key determination circuitry 118 determines key 108 based on parsed contents 115 of packet 114. Key determination circuitry 118 may, for example, determine key 108 based on a media access controller (MAC) address and/or an Internet protocol (IP) address of packet 114. In an example, key determination circuitry 118 computes key 108 by hashing one or more fields of parsed contents 115. As another example, key determination circuitry 118 retrieves key 108 from a ternary content-addressable memory (TCAM) based on one or more fields of parsed contents 115. A hashing approach may consume less power and may utilize less area of IC system 100, relative to a TCAM approach. A TCAM approach may provide lower latency than a hashing approach. Key determination circuitry 118 is not, however, limited to hashing or TCAM approaches. Interface circuitry 120 provides key 108 to LUT 105, receives response 106 from LUT 105, and provides response 106 to packet processing circuitry 110.

Parser circuitry 103 and look-up circuitry 112 may be collectively referred to as pre-processing circuitry 107.

Circuit block 102 further includes packet processing circuitry 110 that processes packet 114 based on response 106. Packet processing circuitry 110 may perform one or more of a variety of processes with respect to packet 114. Circuit block 102 may provide results of the processing as metadata of packet 114. Circuit block 102 may provide parsed contents 115, key 108, and/or response 106 in the metadata of packet 114.

Circuit block 102 further includes bypass circuitry 126 for bypassing key determination circuitry 118, look-up circuitry 112, and/or parser circuitry 103. Bypass circuitry 126 may be useful where circuit block 104 provides parsed contents 115, key 108, and/or response 106 (e.g., within metadata 132), examples of which are provided below. Bypass circuitry 126 may include configurable circuitry (e.g., configurable interconnects/switches). Alternatively, or additionally, bypass circuitry 126 may represent programmable features/functions of a processor/controller.

IC system 100 may further include management control circuitry (MC) 130. MC 130 may program circuit block 104 to provide parsed contents 115, key 108, and/or response 106 in metadata 132. MC 130 may program circuit block 102 (e.g., bypass circuitry 126) to selectively bypass parser circuitry 103, key determination circuitry 118, and/or look-up circuitry 212 based on contents of metadata 132.

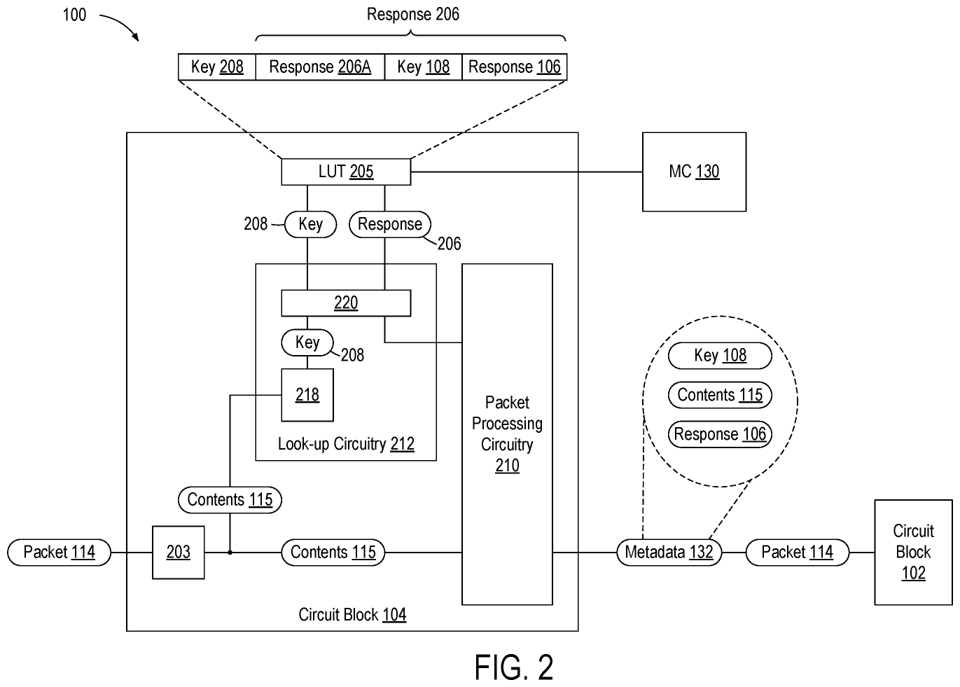

MC 130 may program LUT 105 and/or a LUT of circuit block 104 with keys and responses, such as described below with reference to FIG. 2. FIG. 2 is a block diagram of IC system 100, according to an embodiment. In the example of FIG. 2, circuit block 104 includes packet processing circuitry 203, look-up circuitry 212, a LUT 205, and packet processing circuitry 210. Look-up circuitry 212 includes key determination circuitry 218 and interface circuitry 220. Key determination circuitry 218 determines a key 208 based on parsed contents 115 of packet 114, such as described above with respect to key determination circuitry 118.

MC 130 may program LUT 205 with keys and responses for packet processing circuitry 210. In an embodiment, MC 130 programs LUT 205 with responses that include responses for packet processing circuitry 210, and one or more of keys and responses for circuit block 102. In the example of FIG. 2, MC 130 programs LUT 205 with a response 206 to key 208, in which response 206 includes a response 206A for packet processing circuitry 210, and one or more of key 108 and response 106 for circuit block 102. Further in the example of FIG. 2, circuit block 104 provides parsed contents 115, key 108, and/or response 106 to circuit block 104 as metadata 132 of packet 114.

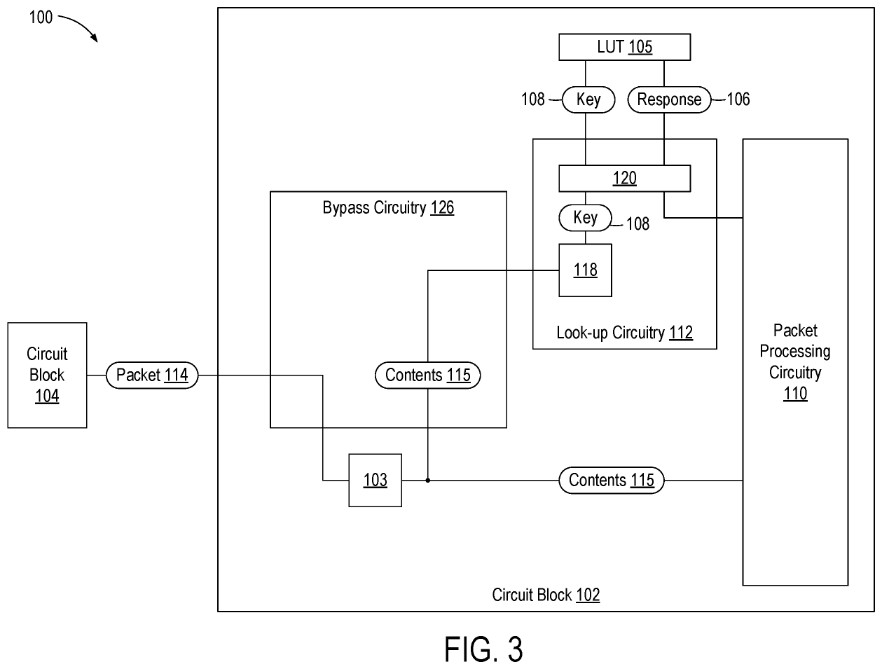

FIG. 3 is a block diagram of IC system 100, in which circuit block 102 operates in a legacy or non-bypass mode, according to an embodiment. In the example of FIG. 2, parser circuitry 103 parses contents 115 of packet 114 and look-up circuitry 112 determines key 108 based on parsed contents 115, receives response 106 from LUT 105, and provides response 106 to packet processing circuitry 110.

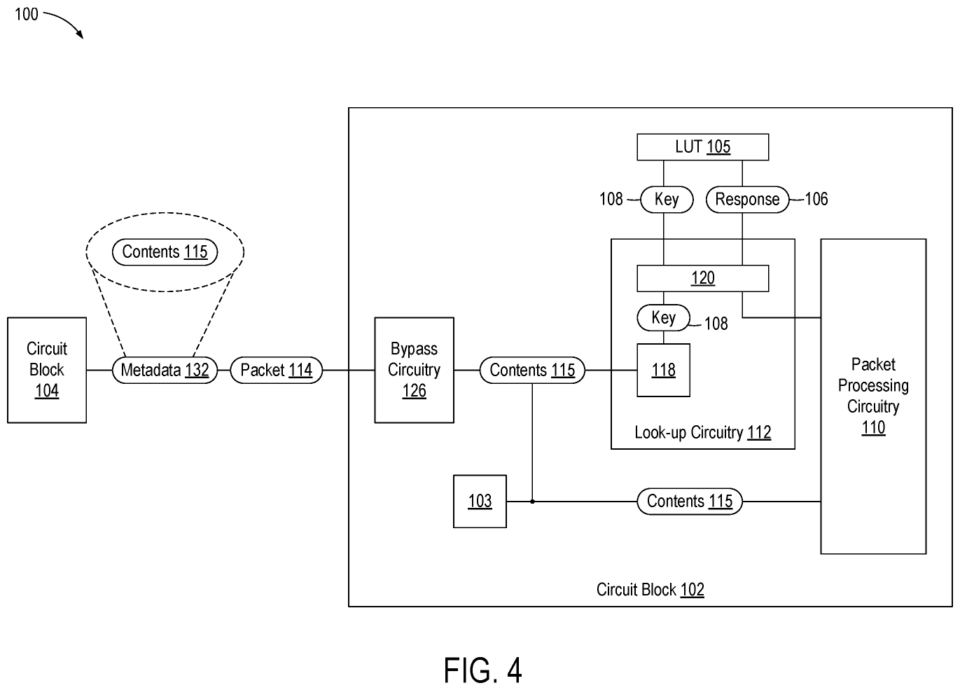

FIG. 4 is a block diagram of IC system 100, in which circuit block 102 operates in a parser bypass mode, according to an embodiment. In the example of FIG. 3, metadata 132 includes parsed contents 115, and bypass circuitry 126 forwards parsed contents 115 of metadata 132 to key determination circuitry 118 and packet processing circuitry 110, bypassing parser circuitry 103.

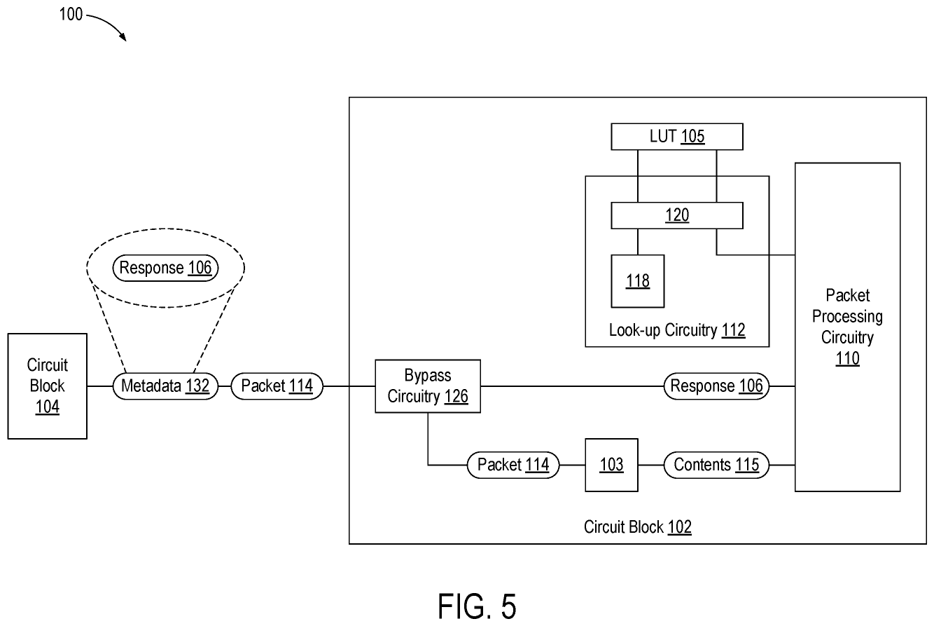

FIG. 5 is a block diagram of IC system 100 in which circuit block 102 operates in a look-up bypass mode, according to an embodiment. In the example of FIG. 5, metadata 132 includes response 106, and bypass circuitry 126 forwards response 106 from metadata 132 to packet processing circuitry 110, bypassing look-up circuitry 112. In the example of FIG. 5, MC system may omit or skip programming of LUT 105, in-whole or in-part during an initialization phase, which may reduce latency of the initialization phase.

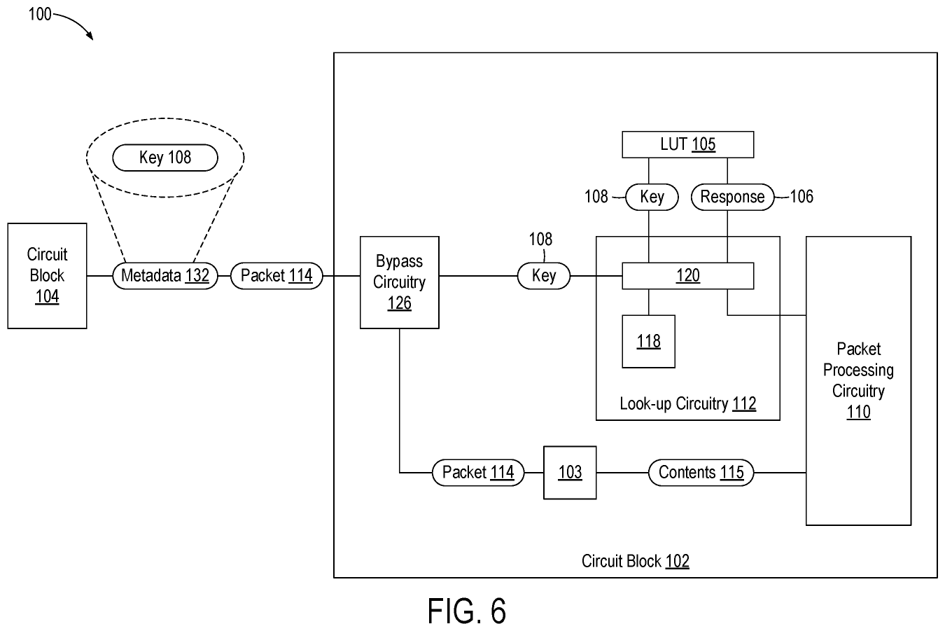

FIG. 6 is a block diagram of IC system 100, in which circuit block 102 operates in a key determination bypass mode, according to an embodiment. In the example of FIG. 5, metadata 132 includes key 108, and bypass circuitry 126 forwards key 108 from metadata 132 to interface circuitry 120, bypassing key determination circuitry 118.

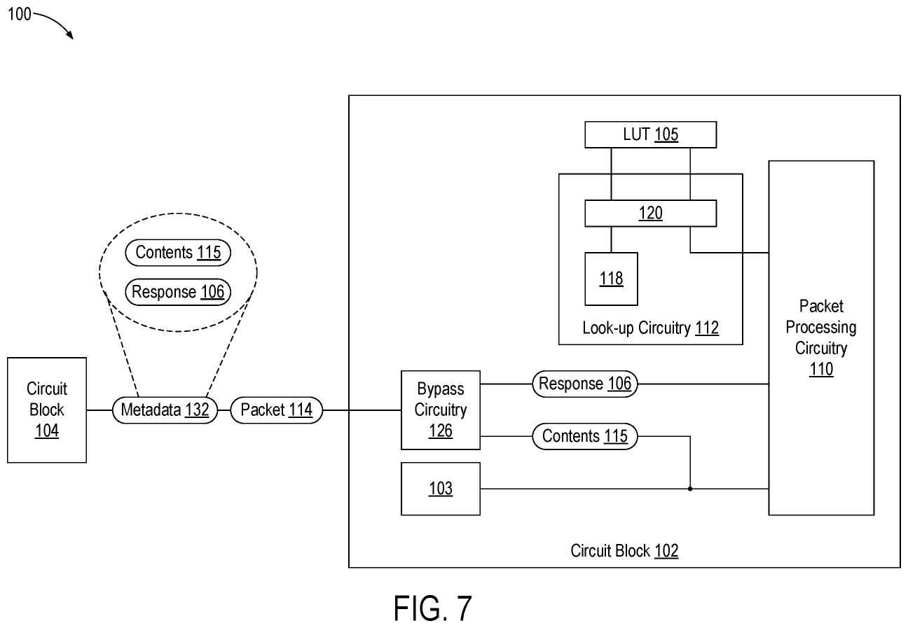

FIG. 7 is a block diagram of IC system 100, in which circuit block 102 operates in a multi-circuit bypass mode, according to an embodiment. In the example of FIG. 6, metadata 132 includes parsed contents 115 and response 106, and bypass circuitry 126 forwards parsed contents 115 and response 106 from metadata 132 to packet processing circuitry 110, bypassing parser circuitry 103 and look-up circuitry 112. In an embodiment, metadata 132 may further include key 108, and bypass circuitry 126 may provide key 108 from metadata 132 to packet processing circuitry 110 and/or other circuitry.

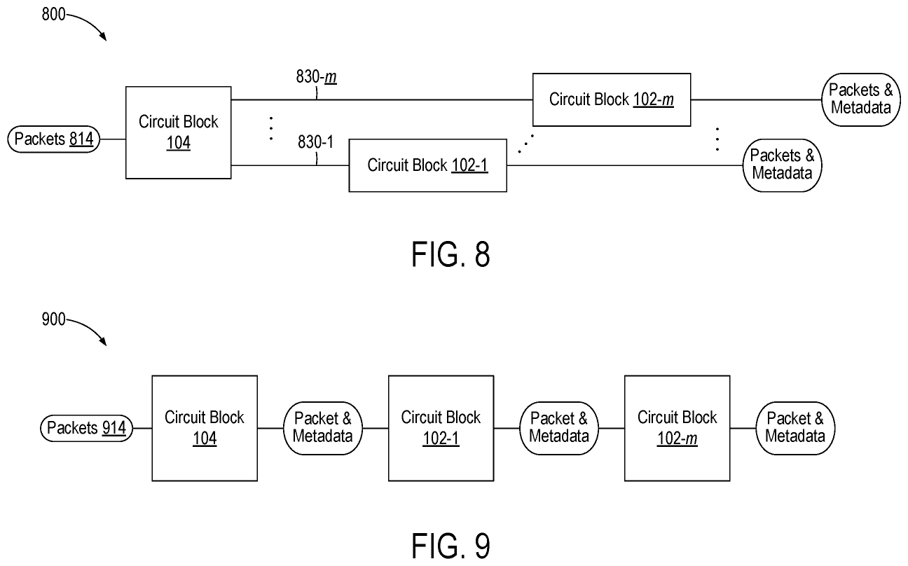

FIG. 8 is a block diagram of IC system 100 in which circuit block 104 provides parsed contents, keys, and/or responses for a stream of packets 814 to multiple circuit blocks 102-1 through 102-m (collectively, circuit blocks 102), according to an embodiment. FIG. 9 is a block diagram of IC system 100 in which circuit block 104 provides parsed contents, keys, and/or responses for a stream of packets 914 to circuit blocks 102. In the example of FIG. 8, circuit blocks 102 are arranged in a parallel fashion. In the example of FIG. 9, circuit blocks 102 are arranged in a serial fashion. IC system 100 may include a combination of parallel circuit blocks and serial circuit blocks 102.

In the examples of FIGS. 8 and 9, circuit block 104 may provide parsed contents, keys, and/or responses to selectable ones of circuit blocks 104 (e.g., based on the corresponding responses). Circuit block 104 may forward the parsed contents, the keys, and/or the responses as metadata of the corresponding packets. MC 130 may program circuit blocks 102 to detect parsed contents, keys, and/or responses in metadata of incoming packets, and to bypass parser circuitry, look-up circuitry, and/or portions of the parser circuitry when the metadata of an incoming packet includes parsed contents, a key, and/or a response.

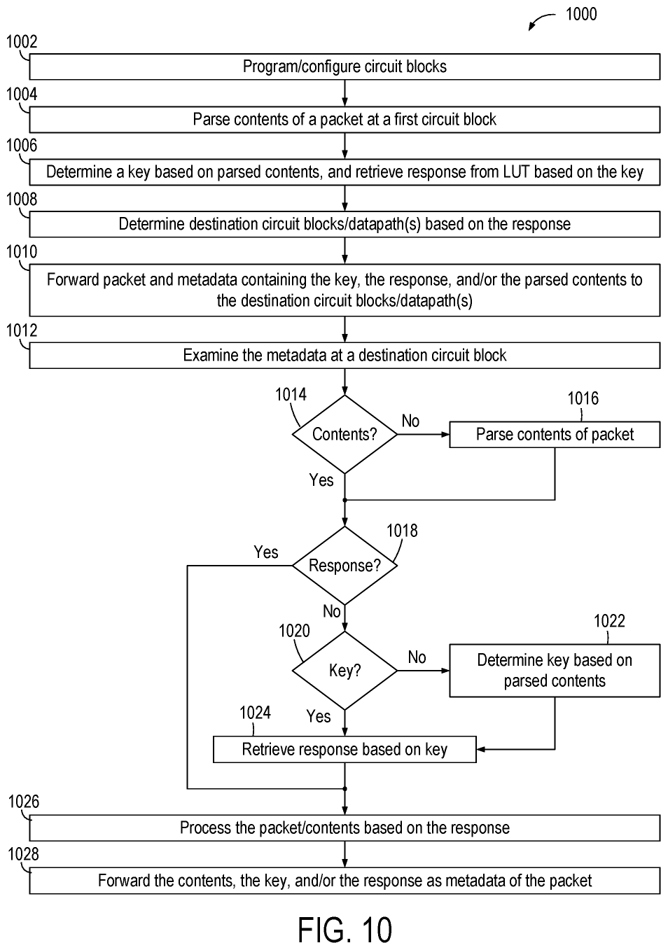

FIG. 10 illustrates a method 1000 of bypassing subsequent lookups in a packet processing pipeline, according to an embodiment. Method 1000 is described below with reference to IC system 100. Method 1000 is not, however, limited to the examples of IC system 100.

At 1002, MC 130 programs and/or configures circuit blocks 102 and 104. MC 130 may, for example, program keys and responses into LUTs 105 and LUT 205. MC may further program/configure circuit block 104 to provide parsed contents of packets and/or contents of results retrieved from LUT 205, in metadata of the packets. MC 130 may program/configure circuit block 102 to detect parsed contents, keys, and/or responses in metadata of incoming packets, and to bypass pre-processing circuitry when the metadata of an incoming packet includes parsed contents, a key, and/or a response. Where MC 130 programs circuit block 104 to provide results from LUT 205 106 in metadata, MC 130 may omit programming results into LUT 105.

At 1004, parser circuitry 302 of circuit block 104 parses contents 115 of packet 114.

At 1006, key determination circuitry 218 of circuit block 104 determines key 208 based on parsed contents 115, and interface circuitry 220 of circuit block 104 retrieves response 206 from LUT 205 based on key 208. Response 206 includes response 206A for packet processing circuitry 210, and further includes key 108 and/or response 106 for circuit block 102. Response 206 may further include keys and/or responses for other circuit blocks 104, such as illustrated in FIG. 8 and/or FIG. 9.

At 1008, circuit block 104 determines destination circuit blocks of packet 114 (e.g., based on parsed contents 115 and/or response 206).

At 1010, circuit block 104 embeds parsed contents 115, key 108, and/or response 106 as metadata 132, and forwards packet 114 and metadata 132 to circuit block 102s. Circuit block 104 may embed keys and/or response for other circuit blocks as metadata for the corresponding other circuit blocks.

At 1012, circuit block 102 receives packet 114 and metadata 132, and examines metadata 132.

At 1014, if metadata 132 does not include parsed contents 115, processing proceeds to 1016, where parser circuitry 103 parses contents 115 from packet 114, such as illustrated in FIGS. 3 and 5. If metadata 132 includes parsed contents 115, bypass circuitry 126 bypasses parser circuitry 103, such as illustrated in FIGS. 4 and 7, and processing proceeds to 1018.

At 1018, if metadata 132 includes response 106, processing proceeds to 1026, where bypass circuitry 126 provides response 106 from metadata 132 to packet processing circuitry 110, bypassing look-up circuitry 112, such as illustrated in FIG. 5. If metadata 132 does not include response 106, processing proceeds to 1020.

At 1020, if metadata 132 includes key 108, processing proceeds to 1024, where bypass circuitry 126 provides key 108 from metadata 132 to interface circuitry 120, bypassing key determination circuitry 118, such as illustrated in FIG. 6. Processing then proceeds to 1024, where interface circuitry 120 retrieves response 106 from LUT 105. If metadata 132 does not include key 108, processing proceeds to 1022, where key determination circuitry 118 determines key 108 based on parsed contents 115, such as illustrated in FIGS. 3 and 4. Processing then proceeds to 1024, where interface circuitry 120 retrieves response 106 from LUT 105.

At 1026, packet processing circuitry 110 processes packet 114 based on response 106.

At 1028, circuit block 102 may forward packet 114 and associated metadata, which may include, parsed contents 115 and/or information contained within response 106 (e.g., a key and/or a response programmed into LUT 105 for a subsequent circuit block).

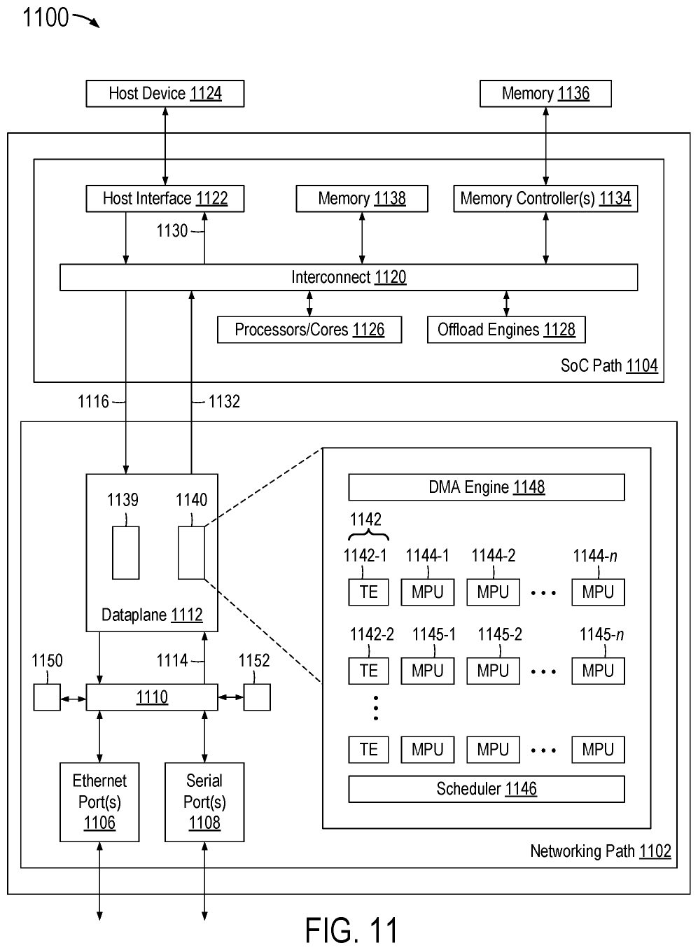

IC system 100 or a portion thereof (e.g., circuit blocks 102 and 104), may form part of a packet processing pipeline of a distributed services platform, such as described below with reference to FIG. 11.

FIG. 11 is a block diagram of a distributed services platform (platform) 1100, according to an embodiment. Platform 1100 may represent an integrated circuit (IC) device, which may include one or more IC dies and/or one or more circuit cards. In the example of FIG. 11, platform 1100 includes a networking path 1102 and a system-on-chip (SoC) path 1104.

Networking path 1102 includes one or more packet-based ports, illustrated here as an Ethernet port(s) 1106. Networking path 1102 may further include a serial port 1108 for sideband signaling. Serial port(s) 1108 may operate in accordance with a Network Controller Sideband Interface (NC-SI) specification maintained by the Distributed Management Task Force, Inc., (DTMF).

Networking path 1102 further includes a packet processing dataplane (dataplane) 1112 that processes incoming packets 1114 from Ethernet port(s) 1106, and outgoing packets 1116 from SoC path 1104. Dataplane 1112 may include a transmit-side pipeline 1139 and a receive-side pipeline 1140, which are described further below.

Networking path 1102 further includes a packet buffer traffic manager 1110 that steers packets between pipelines 1118 and media access controllers (MACs) of Ethernet port(s) 1106. Networking path 1102 may further include packet processing pipelines 1150 and 1152, which may include one or more features described further below with respect to pipelines 1139 and 1140.

SoC path 1104 includes a host interface 1122 that interfaces between interconnect 1120 and a host device 1124. Host interface 1122 may include a media access controller (MAC) that operates in accordance with a peripheral component interconnect express (PCIe) standard managed by the Peripheral Component Interconnect Special Interest Group (PCI-SIG) of Beaverton, OR. Host interface 1122 may present itself to host device 1124 as a PCIe device on a PCIe bus, such as an Ethernet network interface controller (NIC), a non-volatile memory express (NVMe) storage device, and/or other device(s). Host interface 1122 may include multiple PCIe lanes that may connect to other devices. As an example, host interface 1122 may be configured as a PCIe root complex, and the PCIe lanes may connect to multiple host devices and/or multiple NVMe drives.

SoC path 1104 further includes one or more processors or processor cores (processors) 1126. Processors 1126 may include, without limitation, reduced-instruction set computer (RISC) processors, such as ARM processors marketed by Arm Holdings plc, of Cambridge, England. Processors 1126 may perform connection/session setup functions, tear down functions, and/or other functions.

SoC path 1104 further includes one or more offload engines 1128. Offload engine(s) 1128 may perform one or more of a variety of functions on outgoing packets 1130 from host device 1124 and/or incoming packets 1132 from networking path 1102. As examples, and without limitation, offload engine(s) 1128 may include a cryptographic engine and/or an error detection and/or error correction engine. Offload engines 1128 may operate based on hardware queues that are control by pipelines 1118 and processors 1126. Coherent caches of processor 1126 may be coupled with DMA engines of pipelines 1118.

Networking path 1102 and/or SoC path 1104 may further include memory and/or a memory controller. In the example of FIG. 11, platform 1100 includes a memory controller 1134 that accesses external memory 1136. Platform 1100 further includes memory 1138, which may include tertiary content-addressable memory (TCAM), processor cache, random-access memory (RAM), static RAM (SRAM), and/or other memory.

SoC path 1104 further includes an interconnect 1120, which may include a coherent interconnect such as a packet-based network-on-chip (NoC). Interconnect 1120 may connect pipelines 1118 with offload engines 1128, processors 1127, PCIe devices (i.e., via host interface 1122), memory 1138, and/or memory 1136 (i.e., via memory controller(s) 1134).

Receive-side pipeline 1140 is described below. In the example of FIG. 11, receive-side pipeline 1140 includes multiple table engines (TEs) 1142. Each TE 1142 includes a list of features to be extracted from an incoming data object (e.g., a packet and/or data associated with the packet), and a table of feature values. The lists of features and tables of features values may differ amongst two or more of TE 1142. TEs 1142 may be implemented in hardware/circuitry (i.e., without an instruction processor). The list of features and the table of feature values may be programmable, and may be programmed during a start-up procedure.

Each TE 1142 is associated with a set of match-processing units (MPUs). Each MPU may include an instruction processor and memory encoded with instructions that, when executed by the instruction processor, cause the instruction processor to perform one or more functions with respect to a data object (e.g., a packet and/or data associated with the packet). MPUs 1144 may be further programmed to access memory 1136, memory 1138, and/or memory that is accessible via host interface 1122, with a direct-memory access (DMA) engine 1148. DMA engine 1148 may serve as a bridge between a packet domain and one or more memory domains. MPUs 1144 may also be programmed to use one or more offload engines 1128 to process data objects. In FIG. 11, a first TE 1142-1 is associated with MPUs 1144-1 through 1144-n (collectively, MPUs 1144). MPUs 1144 may be programmed with identical instructions.

When receive-side pipeline 1140 receives a data object, TE 1142-1 extracts feature values from the data object based on the corresponding list of features, and compares the extracted feature values to the corresponding table of feature values. If the extracted feature values match the feature values of the table, a scheduler 1146 schedules the data object for processing by one or more of MPUs 1144. When MPUs 1144 complete processing of the data object, the data object is passed to TE 1142-2, and thereafter to subsequent ones of TEs 1142, in a pipeline fashion. Transmit-side pipeline 1139 may be similar to receive-side pipeline 1140.

With reference to FIGS. 1-7, TE 1142-1 and MPUs 1144 may represent circuit block 104, metadata 132 and packet 114 may represent the data object passed from TE 1142-1 to TE 1142-2, and one or more of MPUs 1145-1 through 1145-n may represent packet processing circuitry 110.

In FIG. 11, one suitable language for processing pipelines is the P4 programming language described in a P4Runtime Specification managed by the Open Networking Foundation (ONF) of Palo Alto, CA. The P4 programming language may be used to specify a dataplane of networking devices by combining a number of core abstractions, such as parsers, tables and externs. The abstractions instantiate pipeline objects, which may be managed at runtime to configure desired forwarding behavior. P4 object management may be useful, for example, to create and delete entries of match-action tables. However, the embodiments herein are not limited to any particular type of programming language.

Platform 1100 may be useful for load balancing, networking, storage services, offloading, and/or other purposes. Platform 1100 may be useful/configurable for a variety of applications including, without limitation, as a network interface controller (NIC), as a network node (e.g., a switch or router), and/or as an end-system connected to a network. Platform 1100 may be useful to provide cloud infrastructure functions for networking, storage, security, and/or observability (e.g., to run network, storage, and/or security services for a data center).

The flowchart and block diagrams in the accompanying drawing figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to specific examples, other and further examples may be devised without departing from the basic scope thereof, and the scope thereof is determined by the claims that follow.

What is claimed is:

1. An integrated circuit (IC) system, comprising:
a first circuit block comprising,
first pre-processing circuitry configured to pre-process a packet, including to retrieve a first response from a first look-up table (LUT) based on a first key,
packet processing circuitry configured to process the packet based on the first response, and
bypass circuitry configured to selectively bypass at least a portion of the first pre-processing circuitry based on metadata of the packet.

2. The IC system of claim 1, wherein:
the first pre-processing circuitry comprises first parser circuitry configured to parse contents of the packet; and
the bypass circuitry is further configured to bypass the first parser circuitry if the metadata includes parsed contents of the packet.

3. The IC system of claim 1, wherein:
the first pre-processing circuitry comprises key determination circuitry configured to determine the first key based on contents of the packet, and interface circuitry configured to retrieve the first response from the first LUT based on the first key; and
the bypass circuitry is further configured to bypass the key determination circuitry if the metadata includes the first key.

4. The IC system of claim 1, wherein:
the first pre-processing circuitry comprises look-up circuitry configured to determine the first key based on contents of the packet and to retrieve the first response from the first LUT based on the first key; and
the bypass circuitry is further configured to bypass the look-up circuitry if the metadata includes the first response.

5. The IC system of claim 1, further comprising:
a second circuit block comprising second pre-processing circuitry configured to pre-process the packet, including to retrieve a second response from a second LUT based on a second key, wherein,
the second response comprises pre-processing data for the first circuitry block,
the pre-processing data comprises one or more of the first key and the first response, and
the second circuit block is configured to include the pre-processing data in metadata of the packet.

6. The IC system of claim 5, further comprising:
management control circuitry configured to program the pre-processing data into the second LUT.

7. The IC system of claim 5, wherein:
the bypass circuitry comprises configurable logic; and
the management control circuitry is further configured to program the configurable logic to selectively bypass the at least a portion of the first pre-processing circuitry based on the metadata of the packet.

8. An integrated circuit (IC) device, comprising:
a first circuit block comprising first pre-processing circuitry configured to pre-process a packet, including to retrieve a first response from a first look-up table (LUT) based on a first key, and packet processing circuitry configured to process the packet based on the first response;
wherein the first circuit block is configured to selectively bypass at least a portion of the first pre-processing circuitry based on metadata of the packet.

9. The IC device of claim 8, wherein:
the first pre-processing circuitry comprises first parser circuitry configured to parse contents of the packet; and
the first circuit block is further configured to bypass the first parser circuitry if the metadata includes parsed contents of the packet.

10. The IC device of claim 8, wherein:
the pre-processing circuitry comprises key determination circuitry configured to determine the first key based on contents of the packet, and interface circuitry configured to retrieve the first response from the first LUT based on the first key; and
the first circuit block is further configured to bypass the key determination circuitry if the metadata includes the first key.

11. The IC device of claim 8, wherein:
the first pre-processing circuitry comprises look-up circuitry configured to determine the first key based on contents of the packet and to retrieve the first response from the first LUT based on the first key; and
the first circuit block is further configured to bypass the look-up circuitry if the metadata includes the first response.

12. The IC device of claim 8, further comprising:
a second circuit block comprising second pre-processing circuitry configured to pre-process the packet, including to retrieve a second response from a second LUT based on a second key, wherein the second response comprises one or more of the first key and the first response; and
wherein the second circuit block is configured to provide one or more of the first key and the first response in metadata of the packet.

13. The IC device of claim 12, further comprising:
management control circuitry configured to program the second LUT such that the second response includes one or more of the first key and the first response.

14. A system, comprising:
a packet processing pipeline configured to process a stream of packets, wherein,
the packet processing pipeline comprises a first circuit block comprising first pre-processing circuitry configured to pre-process a packet, including to determine a first key based on parsed contents of the packet, and retrieve a first response from a first look-up table (LUT) based on the first key,
the first response comprises pre-processing data for other circuit blocks of the packet processing pipeline,
the pre-processing data comprises one or more of keys and responses for other circuit blocks, and
the first circuit block is configured to include the pre-processing data in metadata of the packet.

15. The system of claim 14, wherein the first circuit block is further configured to include the parsed contents in the metadata of the packet.

16. The system of claim 14, wherein the other circuit blocks comprise:
a second circuit block comprising second pre-processing circuitry configured to pre-process the packet, including to determine a second key based on the parsed contents of the packet, retrieve a second response from a second LUT based on the second key, and packet processing circuitry configured to process the packet based on the second response;
wherein the second circuit block is configured to selectively bypass at least a portion of the second pre-processing circuitry based on the metadata of the packet.

17. The system of claim 16, wherein:
the second pre-processing circuitry comprises parser circuitry configured to parse the packet; and
the second circuit block is further configured to selectively bypass the parser circuitry if the metadata includes the parsed contents of the packet.

18. The system of claim 16, wherein:
the second pre-processing circuitry comprises key determination circuitry configured to determine the second key based on the parsed contents of the packet, and interface circuitry configured to retrieve the second response from the second LUT based on the second key; and
the second circuit block is further configured to selectively bypass the key determination circuitry if the metadata includes the second key.

19. The system of claim 16, wherein:
the second pre-processing circuitry comprises look-up circuitry configured to determine the second key based on the parsed contents of the packet and to retrieve the second response from the second LUT based on the second key; and
the second circuit block is further configured to selectively bypass the look-up circuitry if the metadata includes the second response.

20. The system of claim 16, further comprising:
management control circuitry configured to program the pre-processing data for the other circuit blocks into the first LUT, and to
program the second circuit block to selectively bypass the at least a portion of the second pre-processing circuitry based on the metadata of the packet.
